(19) United States
(12) Patent Application Publication
(10) Pub. No.: US 2005/0020173 A1
(43) Pub. Date: Jan. 27, 2005

(54) Process of producing windable spunlaid materials and products therefrom

(75) Inventors: Achai Bonneh, Kokhav Yair (IL); Moshe Goldwasser, Tel Aviv (IL)

Correspondence Address: BREINER & BREINER, 115 NORTH HENRY STREET, P. O. BOX 19290, ALEXANDRIA, VA, 22314, US

(73) Assignee: Avgol Ltd., Holon (IL)

(21) Appl. No.: 10/633,493

(22) Filed: Aug. 5, 2003

Related U.S. Application Data
(63) Continuation-in-part of application No. 10/623,519, filed on Jul. 22, 2003, now abandoned.

(51) Int. Cl. B32B 31/00

(52) U.S. Cl. 442/401; 442/409; 156/62.4

(57) ABSTRACT

A process for producing a windable spunlaid material, and a product produced by the process, wherein minimal web compaction occurs and thermal, mechanical and chemical prebonding is not necessary. Filaments are produced and laid on a moving support to provide a web having a machine direction tensile strength of less than 5 N per 5 cm at a basis weight of 50 gsm. The web is then passed through a compacting calender. The filaments of the spunlaid web are not subjected to a temperature exceeding the melting point of the filaments. Preferably, the calender through which the web passes has a surface temperature of less than 130° C. at a calender nip pressure of 30 N/mm. The resulting web is windable under low tension, i.e., a tension of less than 40 N/m. The wound spunlaid material can then be stored and/or transport, to provide a nonwoven material.

### RELATED APPLICATION

This application is a continuation-in-part of U.S. Ser. No. 10/623,519 filed Jul. 22, 2003 entitled “PROCESS OF PRODUCING WINDABLE SPUNLAID MATERIALS AND PRODUCTS THEREFROM”.

### FIELD OF INVENTION

The invention is directed to a process for producing a windable spunlaid material, as well as the material produced thereby. The windable material is useful as an intermediate material suitable for use in subsequent processing, such as hydroentanglement, to provide a nonwoven material. The windable spunlaid material is provided in the absence of thermal, mechanical or chemical prebonding, and with minimal compaction. The spunlaid material is free of or essentially free of bond sites before and after hydroentanglement.

### BACKGROUND OF THE INVENTION

In the production of nonwoven materials, generally one or more filament layers are produced using either adhesive or heat to hold the filaments together. The ability to provide a spunlaid material which is windable would allow for versatility in machinery set up and plant space, and ability to use either underutilized equipment or different types of spunlaid webs more efficiently, e.g., a manufacturer can use different filament-producing machinery to produce different material webs for later treatment, e.g., hydroentanglement. Additionally, it would be beneficial to provide windable spunlaid material without prebonding, since bond sites can limit the quality of product obtained in subsequent processing.

### OBJECTS AND SUMMARY OF THE INVENTION

Accordingly, a primary object of the invention is to provide a process for producing a windable spunlaid material in the absence of prebonding and with minimal compaction.

A further primary object of the invention is to provide a spunlaid material capable of being wound for storage and/or transport and used in a separate subsequent process, in particular hydroentanglement, for producing a nonwoven material.

A further primary object is to produce a spunlaid material free of or essentially free of bond sites to provide a material suitable as an intermediate material adaptable to subsequent processing to produce a nonwoven fabric.

In producing nonwoven fabrics, it is desirable in one line to produce spunlaid filaments and subject those filaments to other processes, such as hydroentanglement, to obtain the nonwoven fabric. However, due to plant layout, location of processing machinery, scheduling, and the like, it may not be possible to provide a continuous line for one step manufacturing. It also has not been previously possible to wind spunlaid material for storage and/or transportation in the absence of some type of prebonding, e.g., chemical, mechanical or thermal prebonding. Prebonding is not desirable in that it provides bond sites which can limit further processing and can damage the filaments by heat degradation. Accordingly, it is desirable to provide a process capable of producing a spunlaid material in the absence of prebonding which can be wound prior to subsequent treatment(s) for producing a nonwoven material. This allows for a two step production of a nonwoven material. The ability to wind the spunlaid material to be used to make a nonwoven material allows the processing machinery to be physically located in different places; allows use of machinery on a more efficient basis (e.g., can use either underutilized or different filament-producing machinery to produce different material for later hydroentanglement); allows optimum use of plant space (e.g., a continuous line requires a large space whereas when machinery can be separated, the same machinery can be adjusted to fit in a more compact space). The ability to wind spunlaid material not subjected to prebonding further enhances the ultimate product quality since bond sites are absent or essentially absent therein. Such bond sites affect the quality of the final nonwoven fabric obtained. As utilized herein, “free of or essentially free of bond sites” and “absent of or essentially absent of bond sites” means no bond sites are present or if a bond site is present, such is merely incidental, i.e., by chance or ensues as a minor consequence, and does not affect further processing.

The process of the invention includes producing filaments, preferably of a thermoplastic polymer, by a conventional spinning process. The filaments are then laid on a moving support. In conventional spinning processes, an air draft is used to draw and attenuate the filaments. Accordingly, at this stage, the filaments are slightly entangled by the air draft mainly due to the attenuation and internal friction between the filaments is present. A weak web results having a machine direction (MD) tensile strength of less than 5 Newton (N) per 5 cm at a basis weight of 50 grams per square meter (gsm). The web is then compressed by a low temperature calender. The temperature and pressure of the calender is such that the temperature of the filaments does not exceed the melting point (MP) of the filaments. The actual temperature will vary with the calender nip pressure, operating speed and mass of filaments being compacted. The surface temperature of the compacting calendar rolls, however, is to be less than 130° C. at a calender nip pressure of 30 N/mm. A preferred operating condition utilizes a calender surface temperature of less than 120° C. and a nip pressure of less than 20 N/mm. After this compaction, the MD tensile strength is increased but remains less than 25 N/mm per 5 cm at a basis weight of 50 gsm. The resulting web is then guided to a winder where the web is wound at low tension, i.e., at a machine tension of 80-200 N across the width of the machine and at a working web tension in a range of from about 15 N/m to 40 N/m. The working web tension is the tension on the web itself during processing given the machine tension setting. Following cross-cutting of the web after winding a predetermined amount of the web, a very low strength, low tension web composed of loose filaments is available for subsequent processing at a different time and/or location.

The process of the invention is unique in that the Theological properties of the individual filaments are not affected in any way. In keeping the temperature of the filaments below their melting point, the original properties of the filaments, including strength, are maintained throughout the process. Additionally, any filament-to-filament compaction areas can be uncompacted through hydroentanglement without damage to individual filaments. This is determinable by measuring the tensile properties of the resulting product. The tensile values will be equal to the theoretical strength of the sum of the individual filaments in their natural form, i.e., after spinning and before compacting.

The wound spunlaid material can be stored or transported between separate locations until subsequent processing occurs. An example of preferred subsequent processing is hydroentanglement to provide a nonwoven material. The nonwoven material provided has improved softness and drape due to the lack of prebonding in the spunlaid web and use of hydroentanglement and, therefore an absence or essential absence of bond sites. Additionally, the hydroentangled material will have high tenacity, high tensile strength and high elongation.

In application, the wound spunlaid material is unwound into a hydroentanglement unit. The filaments are entangled using water jet heads of varying pressures. The web in this stage becomes a fully entangled web having the above-described desired product properties. The hydroentangled products were found to have improved properties over conventional fabrics formed by spunlaid hydroentangling in which the filaments exceed the melting point prior to hydroentanglement. The hydroentanglement product of the invention requires less energy to form in total due to the essential absence of bond sites and the ability of the filaments to move freely during the water jet entangling. In conventional hydroentangled products, some energy from the water jets is dissipated in the breaking of the bonding sites. Additional energy is dissipated by the water being bounced off the bonding sites with an increasing rate related to the size of the bonding area. The total strength of conventional spunlaid fabrics (fabrics that contain bond sites) is further reduced due to the fact that the filaments therein were subjected to thermal and pressure induced degradation, which causes a change in crystallinity, of the filament. This degradation results in the filaments being more brittle around the bond sites.

Accordingly, the invention provides for a unique windable spunlaid material advantageous in itself and in providing through subsequent processing a nonwoven fabric of improved properties.

### BRIEF DESCRIPTION OF THE DRAWINGS

FIG. 1 is a schematic of the extrusion of filaments, laying thereof on a moving support and subjecting to compacting by calendering.

FIGS. 2-5 are photomicrographs of spunlaid materials subjected to hydroentanglement and having bond sites.

FIGS. 6a, 6b and 7 are photomicrographs of spunlaid material subjected to hydroentanglement and being free of bond sites and deformation. FIG. 6b is an enlargement of the noted area of FIG. 6a.

### DETAILED DESCRIPTION OF PREFERRED EMBODIMENTS

The invention is directed to providing a spunlaid web which is windable for storage and/or shipping. This spunlaid web material is useful as an intermediate and adaptable to subsequent processing to provide a nonwoven material. The ability to wind the spunlaid web allows for versatility in the timing of further processing, efficiency in use of machines and the location of processing machinery. Continuous lines for producing a nonwoven material are very beneficial. However, such lines are expensive and require a significant area of dedicated space. By providing for a windable spunlaid web, in particular which does not require mechanical, thermal or chemical prebonding, a manufacturer can use either underutilized or different machines to produce the different spunlaid material and then wind it for placement in storage until the wound spunlaid material can be further processed to produce a desired nonwoven material. The wound spunlaid material also may be shipped to another location for further processing. Thus, all processing machinery is not required to be in one location. Use of plant space will be liberalized since a continuous line is not necessary.

A further advantage of the invention is that the windable spunlaid material is provided in the absence of conventional prebonding techniques. This is beneficial in avoiding the formation of bond sites and allowing further processing where bond sites can interfere in obtaining a nonwoven material with desired properties. For example, when further processing includes hydroentanglement, prebonding affects the softness and drape achievable in a nonwoven material made from spunlaid material subjected to prebonding. A high degree of softness and drape in the final nonwoven material is advantageous since nonwoven materials are conventionally used to produce articles which contact the skin, e.g. as liquid or solid barrier layers or as an absorbent layer, e.g., diapers, adult incontinent products, feminine hygiene products, towels, wipes, napkins and the like.

The windable spunlaid material of the invention can be of a single filament layer or multiple filament layers laid atop one another. The filaments which form the layer or layers are preferably of a thermoplastic polymer. The thermoplastic polymer more preferably is a polyolefin or polyester, most preferably polypropylene. Additionally, certain properties can be provided to the spunlaid material by the incorporation therein of an additive. Properties which can be imparted or changed include the material's phobicity, philicity, flame retardancy, absorbency, antistatic nature and the like. The additive can be added into the mixture used to form the filaments which are spun and laid on a moving support. Alternatively, additives can be incorporated during subsequent processing steps to affect one or more properties of the resulting nonwoven material. The additive can be incorporated physically into the filaments or the filaments topically treated by conventionally used methods.

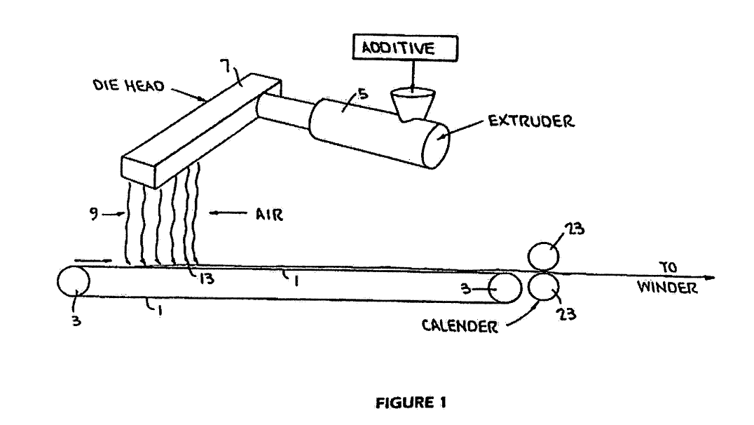

The production of the filaments used to form the spunlaid web is by any conventional method. With reference to FIG. 1, an example of forming the filaments is by extrusion. A moving support (e.g., perforated belt or screen) 1 moving continuously along rollers 3 is provided beneath the exit orifices for extruder 5. Extruder 5 may receive an additive which is extruded through a substantially linear die head 7 to form a plurality of filaments 9 which randomly fall to support 1 to form a layer 13 thereon. Air is blown onto the filaments in order to draw the filaments and subsequently attenuate the filaments as they are attenuated down to the moving support to provide for slight entanglement of the filaments. The extrusion apparatus and general process parameters are as known to one skilled in the art. For example, the die head includes a spaced array of die orifices having diameters preferably in the range of about 0.4 to about 0.7 millimeters (mm). The filaments following extrusion are quenched and drawn, such as by air. The filaments can be continuous or noncontinuous spun melt filaments.

If multiple layers are to be present, additional extruders can be positioned in relation to the moving support upstream or downstream.

In the invention, through producing filaments by conventional spinning and placement on a moving support, slight entanglement occurs due to the exposure of the spun filaments to an airdraft. Internal friction between the filaments also occurs. A very weak web results which has a machine direction (MD) tensile strength of less than 5 Newton (N) per 5 cm at a basis weight of 50 grams per square meter (gsm). The web will be slightly compacted by a low temperature calender. The temperature and nip pressure of the calender is not to cause the filaments to exceed the melting point (MP) of the filaments. Different filaments (even those made from the same base polymer) may have different melting points due to the polymer, presence of melt additives and/or processing conditions used to form the filaments. Critical is the temperature of the filament which is not necessarily the same as the temperature of the equipment. Equipment temperature ranges can vary outside the material ranges and still not be detrimental depending on the basis weight of the filament material and the speed of movement during processing. The critical parameter is to not exceed the melting point of the filaments during calendering so that the as spun geometry nature of the filaments is not changed. It is detrimental for a substantial portion of the filaments to become flattened or otherwise deformed. When the melting point of the filaments is exceeded during compaction, flattening or other deformation will occur along with the formation of filament-to-filament bond sites. Initially, it was believed that higher energy expenditures would be required during subsequent processing, such as hydroentanglement, to uncompact the filaments. However, it has been determined that when the parameters of the invention were followed, even if some flattening occurred, that the energy required to uncompact the filaments was not significant.

Testing was conducted to show the strength properties of spunlaid material after compaction by calendering but before hydroentanglement. The compacted material averages are set forth in Table 1 below.

TABLE 1

| | MD | CD | MD | CD | MD | CD | | | |
|---|---|---|---|---|---|---|---|---|---|
| | Load | Load | Strain | Strain | Strain | Strain | | Compacting | Compacting |
| | @ Peak | @ Peak | @ Break | @ Break | @ 10 N | @ 10 N | Type Of | Temperature | Pressure |
| Test # | (N) | (N) | (%) | (%) | (%) | (%) | Material | (° C.) | (N/cm) |
| 1 | 23.69 | 14.65 | 74.48 | 59.46 | 2.72 | 7.36 | SB 35 gsm | 120 | 30 |
| 2 | 24.00 | 13.04 | 34.08 | 59.79 | 2.47 | 6.63 | SB 40 gsm | 120 | 30 |
| 3 | 8.43 | 4.37 | 48.95 | 53.43 | 2.77 | | SB 60 gsm | 120 | 30 |
| 4 | 5.15 | 5.18 | 43.77 | 47.97 | | | SB 45 gsm | 110 | 30 |
| 5 | 12.00 | 9.50 | 37.96 | 37.87 | 4.27 | 9.29 | SB 35 gsm | 110 | 30 |
| 6 | 25.79 | 13.55 | 45.98 | 53.55 | 2.93 | 5.53 | SB 50 gsm | 120 | 30 |
| 7 | 10.50 | 5.51 | 5.01 | 18.45 | 3.20 | | SB 50 gsm | 115 | 30 |
| 8 | 5.16 | 2.23 | 41.88 | 23.45 | | | SB 50 gsm | 100 | 20 |

The “Compacting Temperature” and “Compacting Pressure” refer to the calender conditions. As shown in Table 1, all conditions resulted in the formation of a windable material. All the variants in Table 1 resulted in windable webs able to be fully disassociated by hydroentanglement. Any materials, at 50 gsm basis weight, made with conditions higher than 130° C. and 30 N/mm resulted in webs with bond sites unable to be disassociated by hydroentanglement and, thus, were not acceptable material. These exact conditions will vary with material basis weight and throughput speed.

If temperature increase is too extreme, such can change the amorphous properties of the filaments. In such instance, the change can not be recovered from through subsequent processing.

When the melting point of the filaments is not exceeded, there is no change in the fundamental properties of the filaments.

Thus, the actual temperature will vary with the calender nip pressure, operating speed and mass of filaments being calendered and other filament process conditions which impact upon filament morphology. For example, the calender surface temperature's effect on the filaments running through the calenders varies depending on the speed of throughput. Thus, the temperature of the calender may be 50° C. above the melting point of the filaments but if the line speed is adequately fast, such temperature will not result in the melting of the filaments. Thus the critical temperature is of the filaments. This is controlled by controlling the surface temperature of the calender so that it is less than 130° C. at a calender nip pressure of 30 N/mm. A preferred operating condition is a calender surface temperature of less than 120° C. and a pressure of less than 20 N/mm. Following this compaction, the machine direction tensile strength is increased but is still less than 25 N/5 cm at a basis weight of 50 gsm.

With reference to FIG. 1, calendering is preferably through a pair of heated rolls 23. After calendering, the web is guided to a conventional winder where the web is wound at a very low tension. The tension on the web is preferably in a range from about 15 N/m to 40 N/m, more preferably from 20 N/m to 35 N/m. Once a predetermined amount of web is wound, the web is cross cut. The wound web at this stage is a low strength, low tension web composed of loose fibers.

The process of the invention is unique since the Theological properties of the individual filaments are not affected in any way. By keeping the temperature of the filaments below the melting point of the filaments, the original properties of the filaments (including strength) are maintained throughout processing of the filaments. Further, any filament-to-filament compaction areas can be uncompacted by subjecting the web to hydroentanglement without damaging any individual filaments, i.e., all filaments are returned to their original pre-compaction state. This has been supported by measuring the tensile properties of the product following hydroentanglement. The tensile values of the product should be equal to the theoretical strength of the sum of the individual filaments in their natural form, i.e., after spinning and before calendering.

The wound spunlaid material of the invention can then be stored until ready for further processing or transported to another location where further processing will be conducted.

In a preferred embodiment, the wound spunlaid material is subjected to hydroentanglement. Since the spunlaid material is not subjected to any prebonding and entanglement is provided by water, the resulting nonwoven material has excellent softness and drape. The nonwoven material is free of or essentially free of bonding sites and deformation damage.

In further processing by hydroentanglement, the wound web of spunlaid material is unwound into a hydroentanglement unit as known in the art. The filaments of the web are entangled therein by a plurality of water jets, for example preferably up to seven water jets at varying pressures within a range of from about 50 bar to 300 bar. During hydroentanglement, the web becomes a wholly entangled web having the desired properties of high tenacity, high tensile strength, high elongation, improved softness and improved drape. These properties are much better in the nonwoven product of the invention, especially as to strength, softness and drape, over conventional nonwoven products formed by spunlaid hydroentangling where the temperature of the filaments exceeds the melting point of the filaments prior to hydroentanglement.

Using the spunlaid material of the invention to form a nonwoven product results in the use of less energy to form the nonwoven product due to the ability of the filaments to move freely during the water jet entangling. In conventional nonwoven products obtained by hydroentangling, the spunlaid material has been subjected to prebonding. With such conventional materials, a portion of the energy from the water jets is dissipated in breaking the bonding points. Additional energy is dissipated by being bounced off of the bonding points with the rate increasing with a larger bonding area. The total strength of these conventional nonwoven fabrics therefore is further reduced due to the fact that the filaments were subjected to thermal- and pressure-induced degradation of the filaments. Such degradation causes a change in the crystallinity of the filaments thereby making the filaments more brittle around the bond site edges.

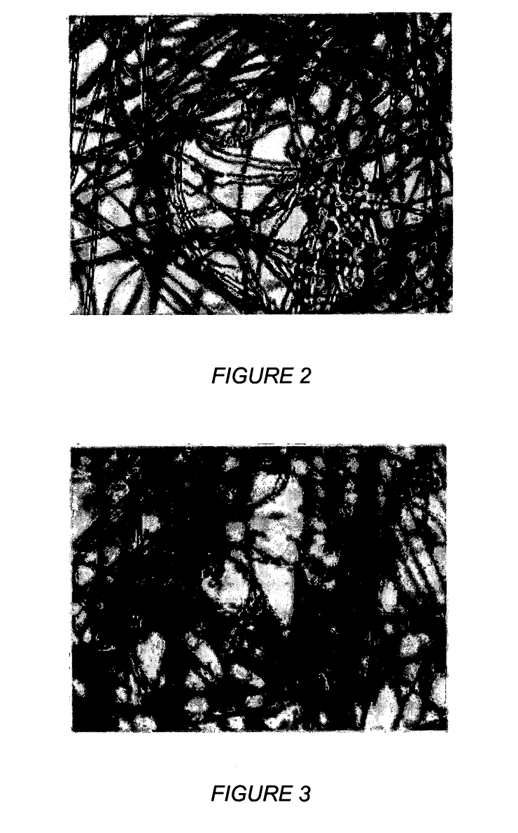

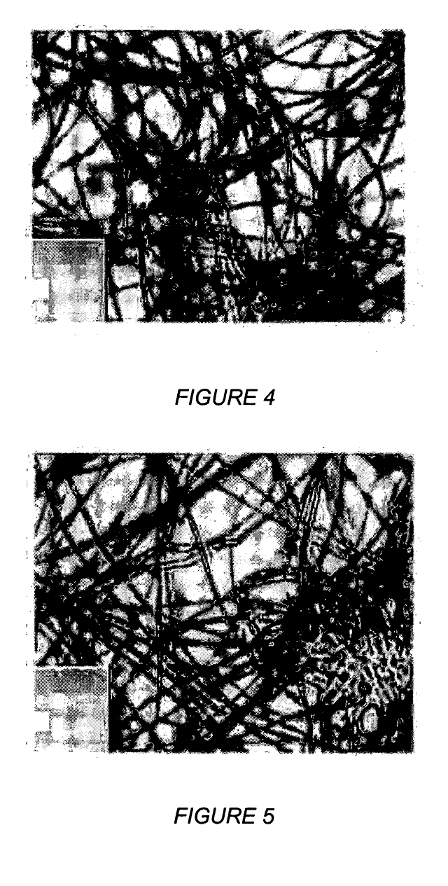

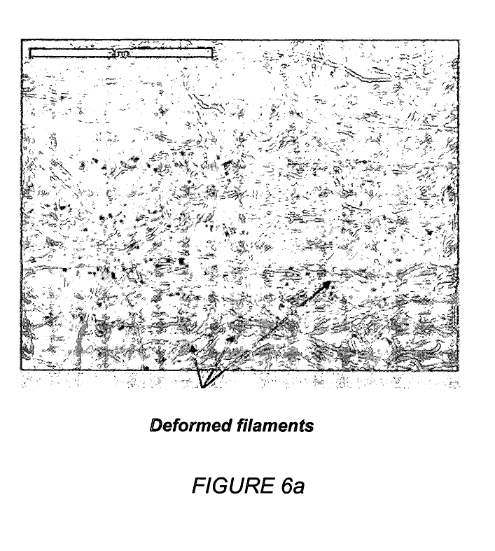

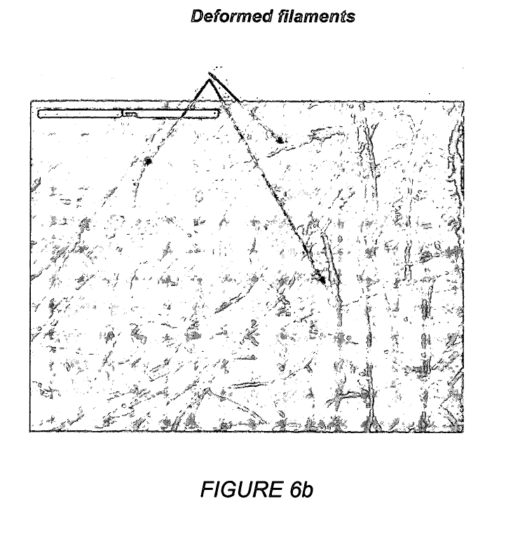

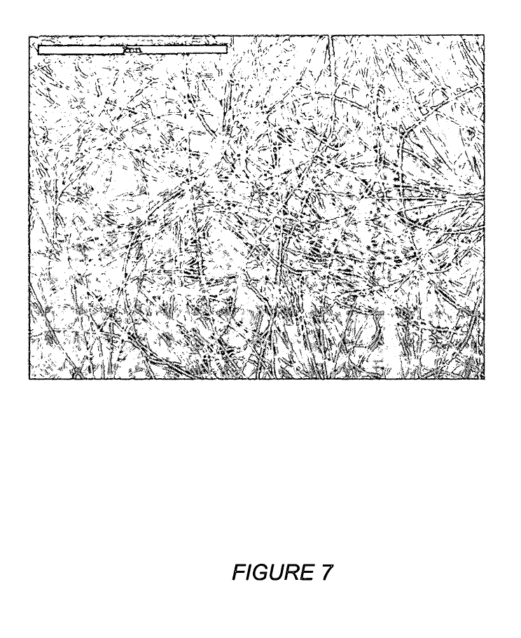

FIGS. 2-5 are photomicrographs showing a nonwoven product resulting from the hydroentanglement of a spunlaid material where the filaments were exposed to temperatures exceeding the melting point of the filaments. FIGS. 6a, 6b and 7 are photomicrographs showing a nonwoven product resulting from hydroentanglement of the spunlaid material of the invention where the filaments were not exposed to temperatures exceeding the melting point of the filaments. All materials are 100% spunlaid polypropylene resin having the same fiber diameter. The materials were subjected to melt extrusion, were spunlaid and subjected to hydroentanglement. FIGS. 2-5 show that when the melting point of the filaments is exceeded that bond sites are present after hydroentanglement, i.e., the hydroentanglement energy was insufficient to fully disassociate the bond sites formed in the spunlaid material; however, it is sufficient to break some of the filaments at the edges of the bond sites. In FIGS. 6a, 6b and 7 (FIG. 6b being an enlargement of an area shown in FIG. 6a, i.e., the scale shown in FIG. 6a being 2 mm and the scale shown in FIG. 6b being 1 mm), material made in accordance with the invention, even following compacting, showed no evidence of bond sites or broken filaments following hydroentanglement. The only change evident is slight deformation of a small number of isolated filaments. These deformations, however, do not form bond sites, nor do they result in filaments being broken.

The nonwoven materials of the invention are useful in a wide variety of applications. For example, the nonwoven material is useful as a component of absorbent products such as disposable diapers, feminine hygiene products, adult incontinence products; medical products which contact the human skin such as surgical gowns and masks; disposable dry or wet wipes (both plain and impregnated dry wipes); industrial garments; filtration media; etc. The nonwoven material of the invention is in particular well suited for those applications requiring both high strength and soft hand feel. The nonwoven material is also suitable for use as a barrier layer for retaining solids and liquids. Continuous filament spunmelt webs subjected to water jet bonding have improved wet strength properties making the material in particularly useful in wet wipe applications, such as baby wipes, hard surface cleaning wipes, general purpose solution-containing wipes, specialty wipes having graphics applied thereto, and the like. Dry wipes include static dusting wipes or mops and wipes impregnated with a substance which is activated on addition to water.

The spunlaid material of the invention, following hydroentangling, further can be provided with a pattern, such as by conventional embossing or the like, to provide aesthetic appeal and/or enhancing fluid absorption, fluid retention, and fluid channeling characteristics in the nonwoven material.

As will be apparent to one skilled in the art, various modifications can be made within the scope of the aforesaid description. Such modifications being within the ability of one skilled in the art form a part of the present invention and are embraced by the appended claims.

1. Process for producing a windable spunlaid material comprising
producing thermoplastic polymer filaments;
laying the filaments upon a moving support to provide at least one layer with a machine direction tensile strength of less than about 5 N per 5 cm at a basis weight of 50 gsm;
passing the at least one layer through a compacting calender having a surface temperature and nip pressure such that said temperature and said nip pressure do not cause the filaments of said at least one layer to exceed a melting point of the filaments; and
winding the at least one layer at a tension of less than about 40 N/m;
wherein said at least one layer is provided in absence of prebonding of said filaments.

2. Process for producing a windable spunlaid material comprising
producing thermoplastic polymer filaments;
laying the filaments upon a moving support to provide at least one layer with a machine direction tensile strength of less than about 5 N per 5 cm at a basis weight of 50 gsm;
passing the at least one layer through a compacting calender having a surface temperature of less than about 130° C. at a calender nip pressure of about 30 N/mm; and
winding the at least one layer at a tension of less than about 40 N/m;
wherein said at least one layer is provided in absence of prebonding of said filaments.

3. Process according to claim 1 or 2 wherein said filaments are produced from a polyolefin.

4. Process according to claim 3 wherein said polyolefin is polypropylene.

5. Process according to claim 1 or 2 wherein said filaments are produced from a polyester.

6. Process according to claim 1 or 2 wherein the surface temperature of said calender is less than about 120° C.

7. A process according to claim 1 or 2 further comprising including an additive in said producing of the filaments.

8. A process according to claim 1 or 2 further comprising incorporating an additive in said at least one layer.

9. Process of forming a nonwoven material comprising
producing thermoplastic polymer filaments;
laying the filaments upon a moving support to provide at least one layer with a machine direction tensile strength of less than about 5 N per 5 cm at a basis weight of 50 gsm;
passing at least one layer through a compacting calender having a surface temperature and nip pressure such that said temperature and said nip pressure do not cause the filaments to exceed a melting point of the filaments;
winding the at least one layer at a tension of less than about 40 N/m; and
unwinding the at least one layer and subjecting said at least one layer to hydroentanglement to provide a nonwoven material;
wherein said at least one layer is provided in absence of prebonding of the filaments.

10. Process of forming a nonwoven material comprising
producing thermoplastic polymer filaments;
laying the filaments upon a moving support to provide at least one layer with a machine direction tensile strength of less than about 5 N per 5 cm at a basis weight of 50 gsm;
passing the at least one layer through a compacting calender having a surface temperature of less than about 130° C. at a calender nip pressure of about 30 N/mm;
winding the at least one layer at a tension of less than about 40 N/m; and
unwinding the at least one layer and subjecting said at least one layer to hydroentanglement to provide a nonwoven material;
wherein said at least one layer is provided in absence of prebonding of the filaments.

11. Process according to claim 9 or 10 wherein said filaments are produced from a polyolefin.

12. Process according to claim 11 wherein said polyolefin is polypropylene.

13. Process according to claim 9 or 10 wherein said filaments are produced from a polyester.

14. Process according to claim 9 or 10 wherein the surface temperature of said calender is less than about 120° C.

15. A process according to claim 9 or 10 further comprising including an additive in said producing of the filaments.

16. A process according to claim 9 or 10 further comprising incorporating an additive in said at least one layer.

17. Process according to claim 9 or 10 wherein said hydroentanglement is carried out utilizing a plurality of water jets with varying pressures.

18. A spunlaid product produced by the process according to claims 1, 2, 9 or 10.

19. A spunlaid material comprising a plurality of thermoplastic polymer filaments being at least partially entangled and forming at least one layer in absence of prebonding, wherein the filaments of said at least one layer are not subjected to a temperature exceeding a melting point of the filaments, and said at least one layer is windable under a tension of less than about 40 N/m.

20. A material according to claim 19 wherein the thermoplastic polymer of said filaments is a polyolefin.

21. A material according to claim 20 wherein said polyolefin is polypropylene.

22. A material according to claim 19 wherein the thermoplastic polymer of said filaments is a polyester.

23. A material according to claim 19 further comprising incorporating an additive in said filaments.

24. A material according to claim 19 further comprising incorporating an additive in said at least one layer.

25. A material according to claim 19 wherein said at least one layer is essentially free of bonding sites.
